(19) United States
(12) Patent Application Publication
(10) Pub. No.: US 2015/0304372 A1
(43) Pub. Date: Oct. 22, 2015

(54) Systems for Providing Services in a Voice Conferencing Environment

(71) Applicant: DOLBY LABORATORIES LICENSING CORPORATION, San Francisco, CA (US)

(72) Inventors: Jean-Francois CATZ, Eguilles (FR); Gary SPITTLE, Hillsborough, CA (US)

(73) Assignee: Dolby Laboratories Licensing Corporaton, San Francisco, CA (US)

(21) Appl. No.: 14/443,747

(22) PCT Filed: Nov. 13, 2013
(86) PCT No.: PCT/US2013/069881

§ 371 Date: May 19, 2015

Related U.S. Application Data
(60) Provisional application No. 61/731,386, filed on Nov. 29, 2012.

(51) Int. Cl. H04L 29/06; H04L 12/26; H04L 12/24

(52) U.S. Cl. CPC H04L 65/403; H04L 41/5054; H04L 43/0876

(57) ABSTRACT

A system according to the invention is highly scalable and includes at least one server cluster comprising a plurality of voice conferencing servers. The at least one cluster further includes one or more performance management systems for handling various tasks such as licensing tasks, real-time and historical performance monitoring, cascading, availability, failover, load balancing, and/or performance optimization.

### CROSS-REFERENCE TO RELATED APPLICATIONS

The present application claims priority to U.S. patent application No. 61/731,386, filed on 29 Nov. 2012, which is herewith incorporated in its entirety.

### TECHNICAL FIELD

The current invention concerns various embodiments of a (e.g. voice) conferencing architecture, specifically including high scalability.

### SUMMARY OF THE INVENTION

The suggested Architecture provides high quality audio processing capabilities, preferably implemented in the Cloud. Its flexible componentized and multi-tier architecture enables Communication Service Providers to select among a wide range of integration and deployment scenarios.

### BRIEF DESCRIPTION OF THE DRAWINGS

FIG. 1 depicts a reference architecture diagram;

FIG. 2 depicts an embodiment of a Performance Management System, which can be implemented e.g. in a Performance Server;

FIG. 3 exhibits further details of the Performance Management System, specifically interfaces with other functions;

FIG. 4 shows a licensing process, which can e.g. be implemented as a License Manager function in the Performance Server;

FIG. 5 depicts an automatic configuration process for Conferencing Servers;

FIGS. A & 6B show an example of Real Time Performance monitoring functions;

FIG. 7 exhibits Real (or near real) Time monitoring functions for one Conferencing Server; and

FIGS. 8A & 8B depict examples of monitoring and data gathering call flows;

### DETAILED DESCRIPTION OF THE INVENTION

Systems allowing for a highly scalable (e.g. voice) conferencing architecture are laid down in the independent claims. Preferred embodiments are described in the dependent claims.

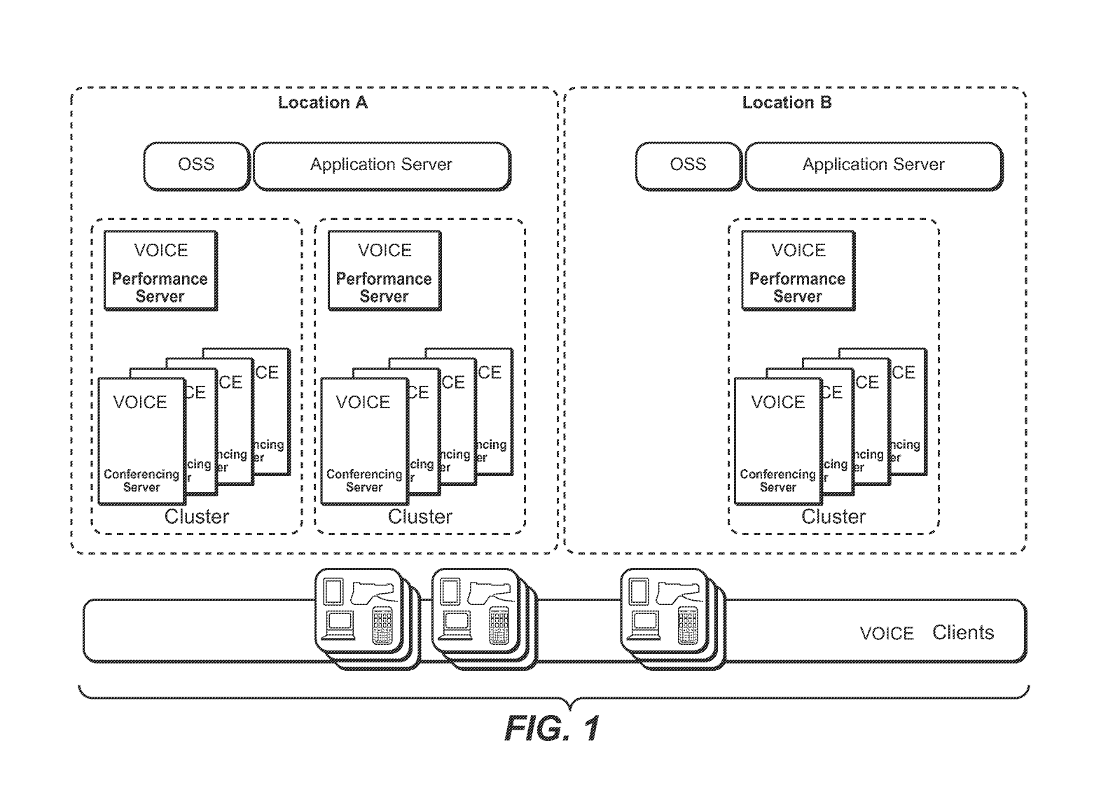

As shown in FIG. 1, Voice Conferencing Servers can be deployed as part of a pool of servers called a Cluster. A Cluster is an autonomous virtual component containing one or more Voice Performance Management Systems and an unlimited number of Voice Conferencing Servers.

One or more Clusters of Servers can be deployed in a specific physical location such as a Data Center or Point of Presence (POP).

The figure (i.e. FIG. 1) shows a cluster of servers being collocated. However, a specific Cluster can contain Voice Conferencing Servers running from different physical locations, allowing high availability and data recovery capabilities across different geographical regions.

Conferencing Servers are activated dynamically within each Cluster. They can be moved, in a virtual sense, from one Cluster to another without any configuration task. The conferencing server is assigned to a single cluster.

Conferencing Servers become automatically managed upon a license-based activation within each Cluster. No configuration is required. The licensing limitations on performance, such as available ports, can be freely distributed within the cluster of servers.

Large conferences can be hosted in one single Conferencing Server, or across multiple Conferencing Servers within the same Cluster, or even across multiple Clusters. A conference can be dynamically reassigned to a different set of clusters or servers. A conference can be split across servers depending on the types of external connections that are used, e.g. such that all PSTN traffic is loaded onto a single server and all VOIP traffic onto a different server. Alternatively, resource loading can be balanced across multiple servers.

Conferencing Servers can run independently from each other within the same Cluster, and can but are not required to communicate to each other.

However, data routing is required between servers when a single conference is distributed between multiple servers or clusters.

Conferencing Servers may use a standard protocol such as Session Initiation Protocol (SIP) to communicate with a Voice Performance Server.

### Voice Performance Management System

A Voice Performance Management System (DPMS) is a key component of the Voice Service Architecture.

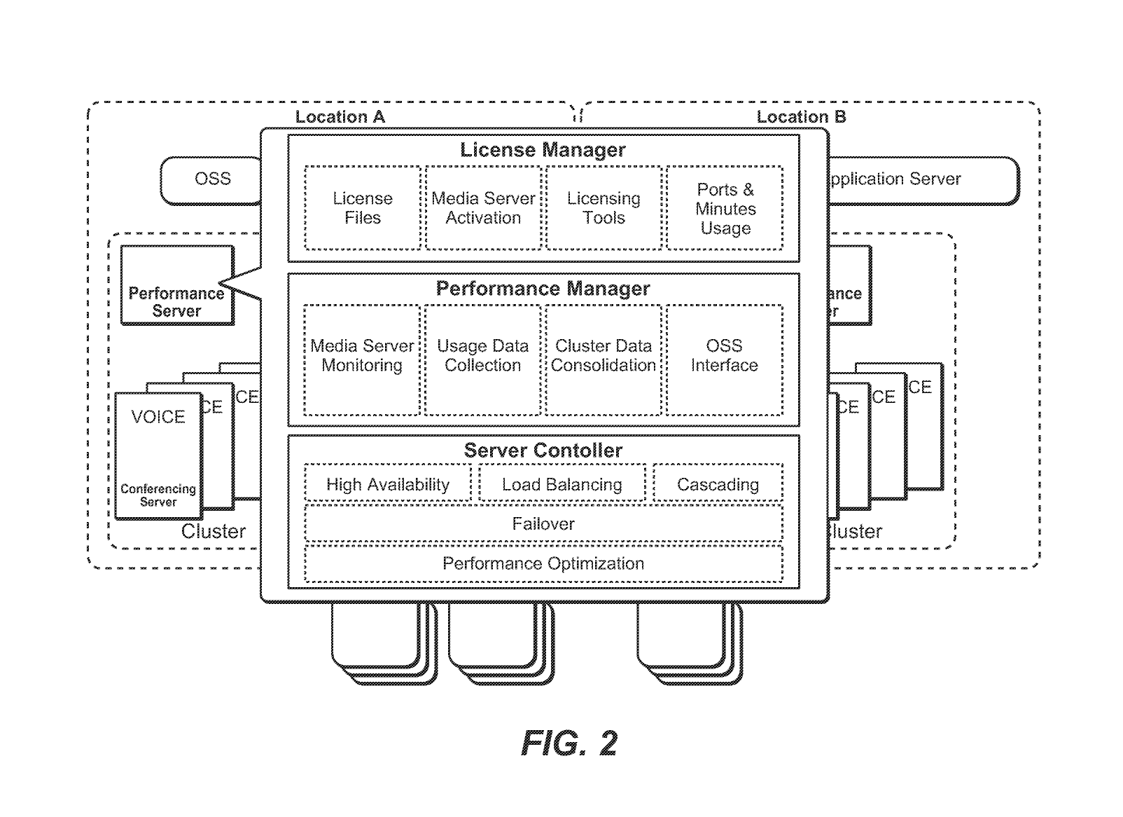

DPMS is responsible for handling one or more or all of the following tasks within a Cluster, as shown in FIG. 2:
Licensing
Real-Time and Historical Performance Monitoring
Cascading, High Availability, Failover, Load Balancing and Performance Optimization

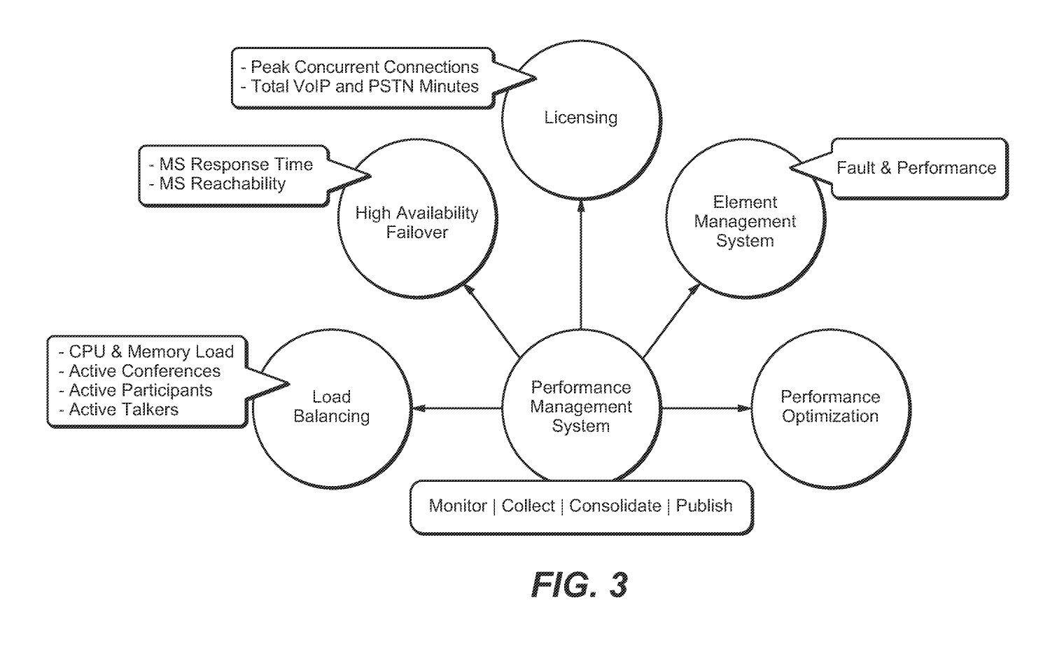

DPMS collects and consolidates real-time and historical metrics and provides interfaces to different internal and external software components, as shown in FIG. 3.

### Flexible Licensing Management

Licenses are handled at the Cluster level. There is no need to install any license file manually on each Conferencing Server. Each Voice Conferencing Server (Media Server) is automatically activated (licensed) during the startup process by getting its license key from the DPMS.

When Conferencing Server needs to be moved from one Cluster to another, it will automatically be licensed within the new Cluster without any configuration. Conferencing Server re-allocation process is fully automated. This involves removing the license allocation from one cluster and reallocating the license components from the new cluster.

DPMS can handle different types of licenses, such as Development or Production.

Licensing change management is done dynamically; no Server restart is required to increment or decrement licensed resources.

Voice Conference Server within a Cluster can be licensed based on different metrics, and shall not be limited to Peak Concurrent Connections (PCC).

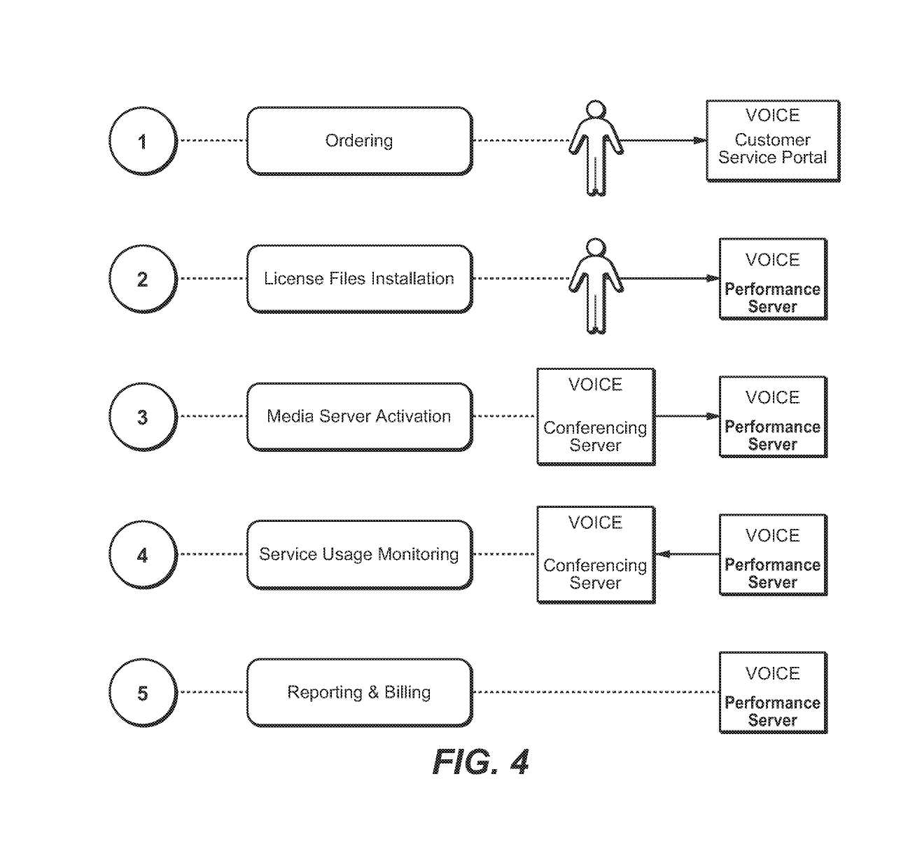

A more complete licensing process is shown in FIG. 4.

Another stage of creating license codes based on a request from a customer can also be added. This stage then will have a validation component to ensure the correct license has been generated.

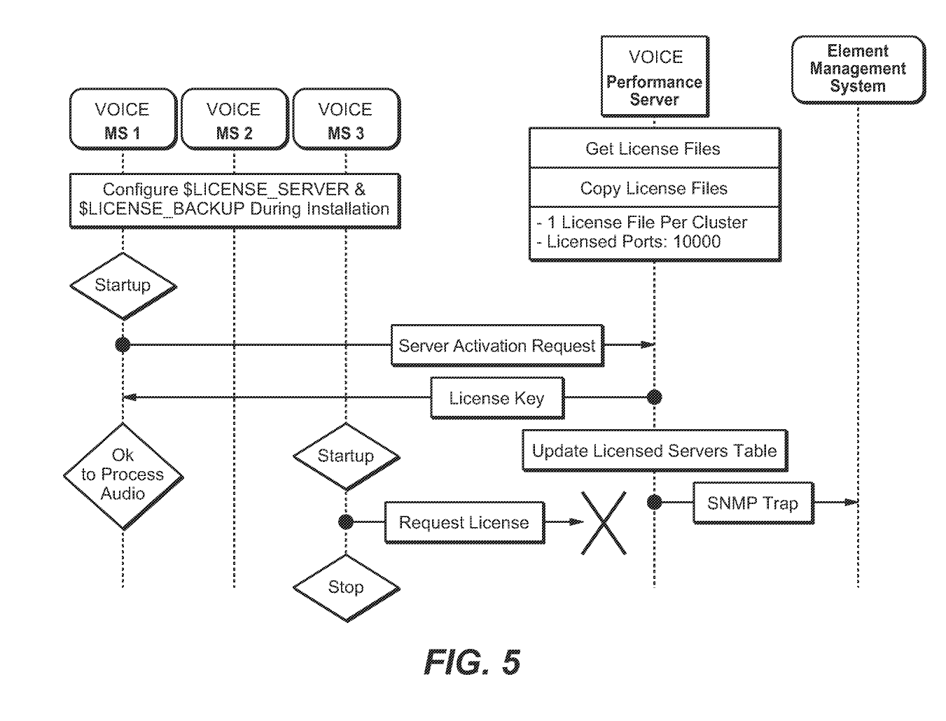

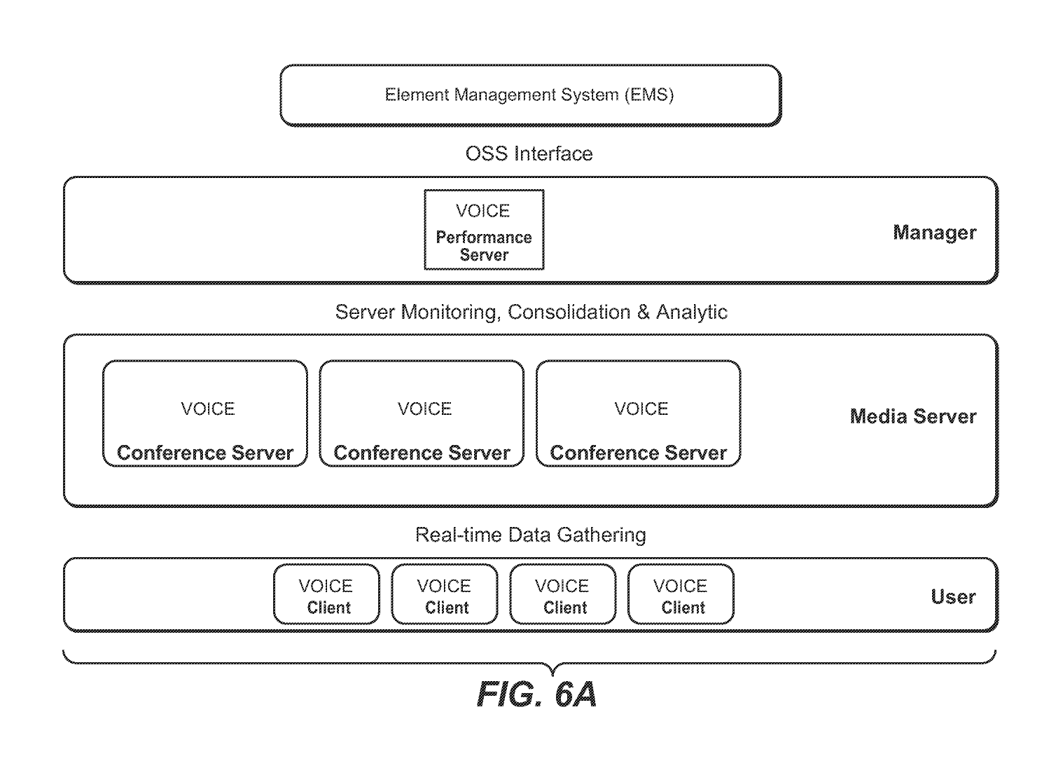

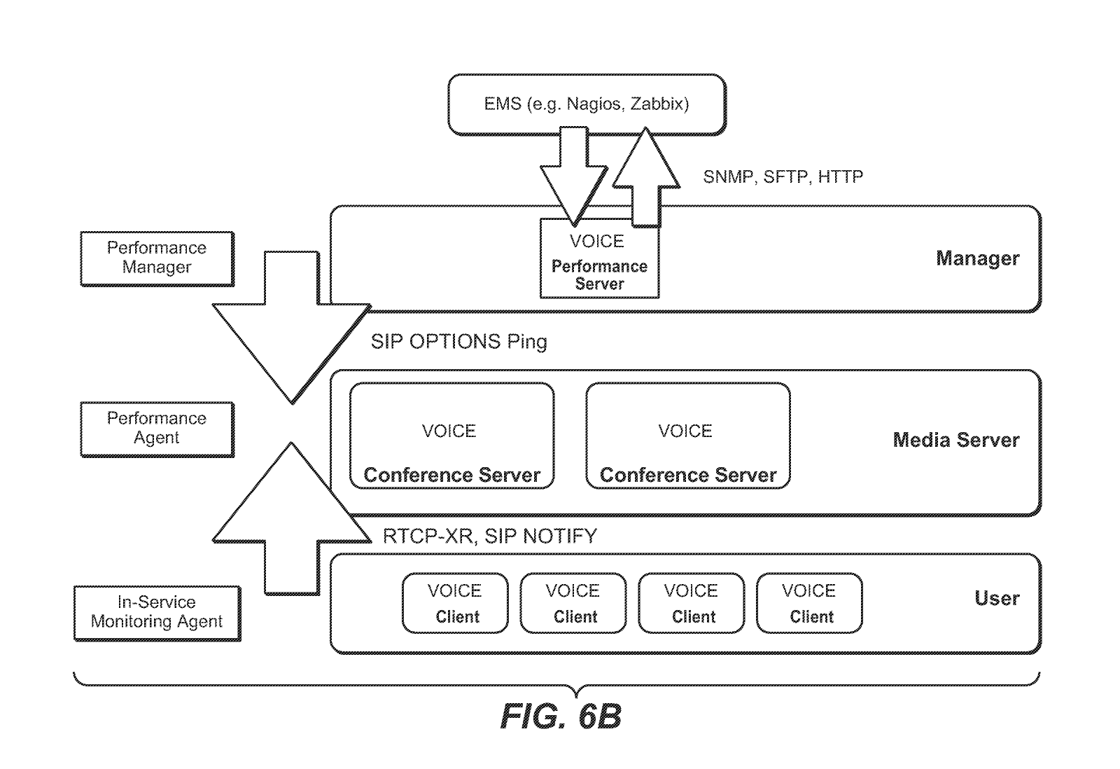

There is no need to configure in advance the list of Conference Servers in a Cluster at the DPMS level. DPMS learns and updates the “licensed server” list automatically upon receiving a server activation request from each Conference Server, as shown in FIG. 5.

In order to avoid any single point of failure, DPMS can be deployed with 1 primary server+1 backup server, where the backup system is running in standby mode until the primary system fails. Each system communicates with the other in real-time and the failover mechanism is fully automated.

If the DPMS and its backup fail, there should be no interruption to the performance of the conference servers, therefore allowing conferences to continue. Metrics will continue to be logged within each of the conference servers. The DPMS will be updated with the most recent information when it comes back online and reconnects to the conference servers.

License checks are only done during initial Conference Server activation, so that DPMS availability never affects any real-time operations (e.g. Primary DPMS and its Backup system can fail without affecting, in any circumstances, the Conference service availability and quality).

DPMS provides a set of tools in order to manage Cluster licenses. License tools can be used using standard Command Line Interface (CLI) or/and Simple Network Management Protocol (SNMP):

### Determine License Usage

List activated servers from which DPMS received activation requests
List active media servers
List unreachable media servers
List “threshold violation usage”
Get current Peak Concurrent Connections (or any selected metric used for licensing purpose)
Get minute/hourly/daily/weekly/monthly PCC value (this can be for each type of connection, PSTN, VOIP, Dolby, G711, G722, enhanced, basic etc.)

### Refresh Licenses

DPMS is able to send notifications based upon any licensing modifications or new server activation requests. Those notifications can be sent using standard SNMP trap to any external Element Management System (EMS) part of the OSS/BSS platform.

DPMS tracks in near real-time (every minute) usage across multiple Dolby Voice Conference Servers. Licensing data collection, data consolidation across servers and data computation is done by DPMS, which is responsible to send notifications upon license usage threshold violation.

### Real-Time Performance Monitoring

Real-Time Performance Monitoring is a multi-tier architecture, where performance data are provided at the Client level, Conference Server level and Cluster level as they are consolidated by the DPMS (FIGS. 6A & 6B).

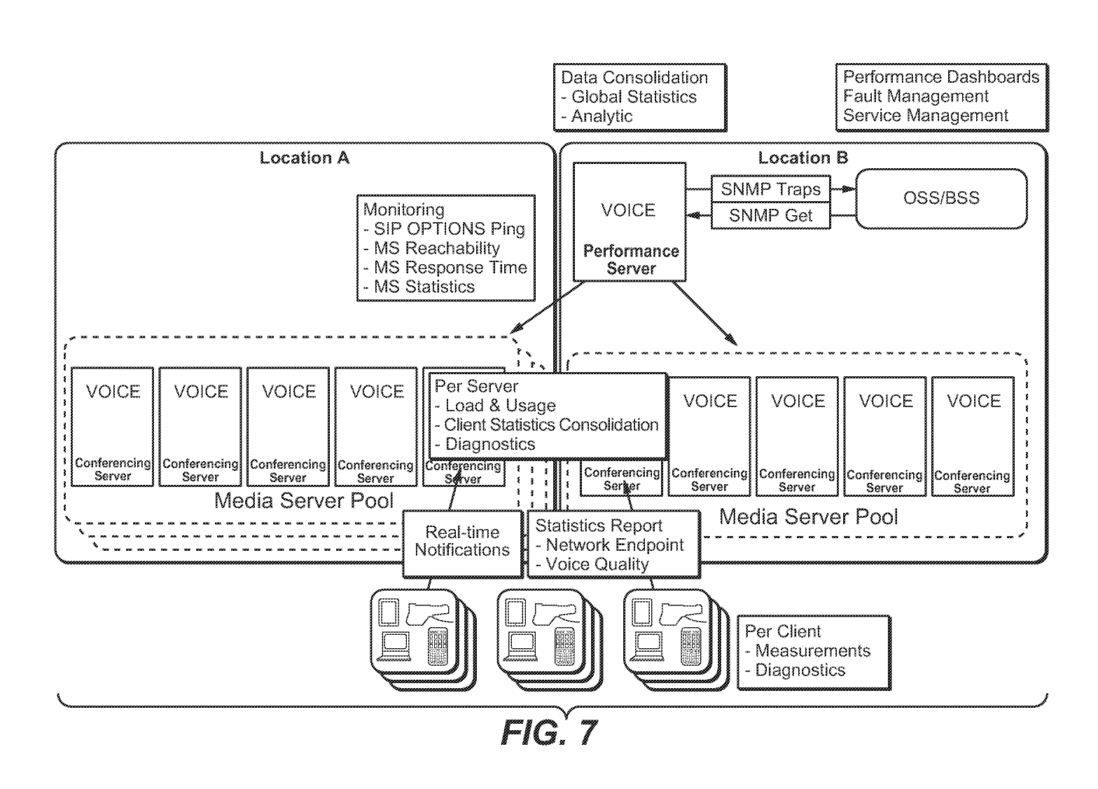

Each Conference Server is monitored in real-time or near real-time within a Cluster, using e.g. standard protocols as shown in FIG. 7.

This multi-layers architecture design allows DPMS to provide end-to-end Performance Monitoring:

Real-time and near real-time session based performance measurement, from client (software or hardware end-point) to Media Server-Conference quality
In Service Monitoring for Audio Quality optimization
Real-time and near real-time Key Performance Indicators data collection, from Client to Server
Real-time session based Root Cause Analysis and Diagnostics
Client based and Server based Data Consolidation and Analytics
End-to-end Audio Quality and Network Impairment measurement link quality

DPMS key functions may include:

Real-Time monitoring
Fault & Performance metrics data collection
Fault & Performance data formatting
Fault & Performance data consolidation
Call Detail Records and Conference Detail Records consolidation
Fault & Performance analytics
Statistic data Publishing, acting as a Data source Provider for OSS/BSS
Performance Optimization to highlight bottlenecks in the system and find the highest consumption of resources.
Dynamic Resource configuration and Allocation

DPMS can employ standard “SIP OPTIONS Ping/Heartbeat” protocol to test reachability and responsiveness of each Conference Server in its Cluster. In the meantime, each component within a Cluster (Conference Server and DPMS) has their own SNMP Agent so they can be monitored by any external EMS.

Standard data channels are used for communication with EMS, providing “typical” performance data. Advanced performance data can be exposed where needed.

As part of a regular Conference Server “SIP Ping” process, the Performance Manager monitors the capability to collect statistic data from each Media Server, and keeps track of each Media Server reachability.

Each Conference Server is responsible to store and maintain its own Statistics records, until DPMS can collect these records.

Each Conference Server can still operate as usual even if DPMS is down or offline. Performance data can continue to be stored locally, waiting until the next data collection from DPMS. All new records can be stored locally on each Conference Server and can be smoothly and smartly collected by the DPMS at the time this one retrieves its online status.

This open and flexible design approach allows better data accuracy as some components might fail without affecting the overall data collection process.

DPMS can also include an analytic engine, which provides some additional performance data computation based on different criteria, such as:

Timeline data correlation
Object group data correlation
Service Level Agreement business data correlation

Data collected and consolidated by DPMS can be reused for multiple purposes, such as licensing, historical reporting or Service Level Agreement.

This architecture design allows different data gathering approaches, such as:

Regular heartbeat data collection
Event based (e.g. threshold violation, error notification . . . ) when needed
Priority based data collection, when CPU or bandwidth allows processing to proceed

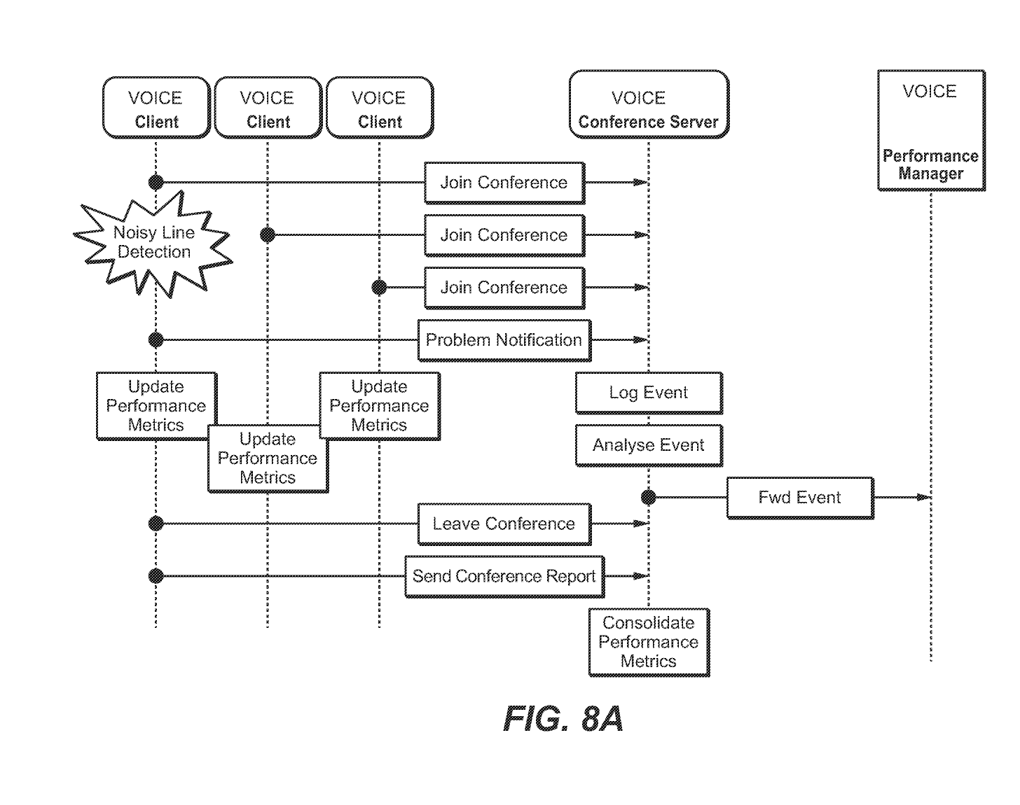

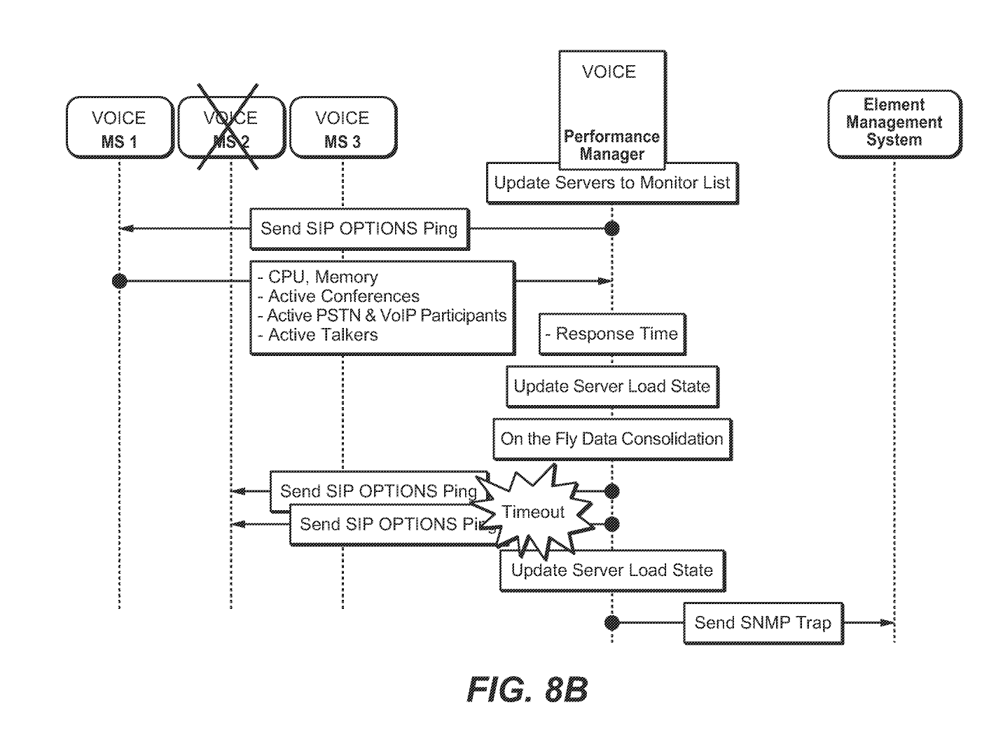

Examples of monitoring and data gathering call flows shown in FIGS. 8A & 8B.

### Performance Optimization

DPMS may also provide for the following functions:

Voice Conference Server High Availability management
Cascaded and Distributed Mixers management
Load Balancing and Dynamic Resource management
Media Performance optimization

### Fault Tolerance and Failover

Decisions to proceed to a failover, to move a participant or conference from one server to another, to route incoming calls to a specific server or region are done based on active real-time monitoring of servers as well as on returned performance metrics values embedded in SIP OPTIONS Ping answers.

DPMS can automate tasks in order to provide automatic redistribution and reconfiguration of resources within a Cluster or across Clusters as required, and maintain the right level of audio quality perceived by the conference participants. Those tasks include:

Move voice processing from one mixer to another
Update voice processing configuration to improve packet delay, jitter buffer, voice frame rate, mixing rules and policies either within the server or by send notifications to the client devices.
Add/Configure transcoder or mixer resources

Performance Optimization is done according to a set of rules, and is based on participant profile criteria, such as:

Type of endpoint and the resources available on the endpoint, devices being used at each endpoint
Type of headset, laptop or mobile client
What other devices are available to the user (but not used by the client)
Which other active applications have access to the mic and speaker
Information about the environment, noise level, echo, etc. . . .
Type of access network (PSTN, 4G/LTE, 3G, internet, IP-VPN)
Participant's location, including region, address, cubical, car, home office, coffee shop
Participants profile (executive, listener, presenter, moderator, customer, partner, team member)

DPMS can move Conferences or Participants sessions from an overloaded Conference Server to a more lightly loaded server to enable graceful recovery. Moving or resource re-allocation process can be based on different criteria, such as apply moves according to conference or session prioritization rules (e.g. CEO quarterly meeting vs. team meeting)

Load balancing decision can be made using any type algorithm based on Conference Server KPIs: Load balancing decision can be handled by Voice Performance System or an external Application Server or any external component through e.g. a standard SIP OPTIONS interface.

The resource management will ensure high level system monitoring is used to prevent process “thrashing”. This is when the management operation continually strives to optimise the system with micro changes without considering the overall impact of the resource used to execute those changes.

DPMS can also handle High Availability, Cascading, Distribution and Failover functions, such as:

Monitor in real-time each Conference Server component (mixer, audio conditioning, IVR, scene manager)
Report in real-time a wide range of load-based Key Performance Indicators (KPIs):
Number of active participants
Number of active conferences
System CPU and Memory load
Number of active talkers

DPMS may also provide software-based High Availability and Automatic Failover capabilities, including:

Conference state resilience
Activate audio stream cascading when required
Move participants seamlessly to new Media Server
Geographic distribution of redundant Media Server when conference states can be replicated across geographically distributed sites

### Advanced Presence & Location Management

Participants to a Business Voice Conference are connected from different locations.

Participants to a Business Voice Conference can join a conference using different devices, with different capabilities, such as:
Standard analogue phone with mono audio only
Standard IP Phone using G.722 wideband codec
Computer's software client with video and spatial audio
Mobile smartphone with spatial audio and no video

A model can be created for each Conference Participant, e.g. according to his/her location, profile, activity, position in a room, number of participants within the same room, and device capabilities.

Each participant location, presence status, talking/listening status, as well as current network activity such as presence of a video stream, presence of a file transfer etc. can be updated in real time.

Based on each participant properties and current activity, this information can be transmitted to an external Presence Server and Location Server through a standard interface. Based on this information, it will then be possible to locate each participant into a map, and going further to map each participant into a room. An external Presence Server would then be able to provide very detailed information about each participant such as:

User participating in a conference right now
User talking and presenting, do not disturb even with chat messages
User listening, available for instant messaging

The network activity knowledge enables an audio and scene processing component about current network activity (e.g. video stream, file transfer), as well as indication about current sharing capabilities for each endpoint in order to provide bandwidth optimization for audio.

In addition to each participant network activity, an audio processing component can also be kept informed about the total number of participants, overall quality delivered and current bandwidth utilization in order to help to optimize the overall multimedia converged data/voice/video experience.

Enhanced Call Detail Records (eCDR)

Through end-to-end performance monitoring capabilities, voice quality metrics can be added as part of traditional Call Detail Records, so that external Reporting and Accounting systems can include those voice quality metrics to their dashboards and reports.

For each participant joining and leaving a conference, each Conference Server can save call signaling and voice quality information at the end of the session. Those CDRs are collected and consolidated on a regular basis by the DPMS component.

Each CDR can contain the following fields:

UserID, UserName, Email, Language, Location, Timezone, Role, SIP URI, IP address
ConferenceID: the conference ID joined by the user
Joining info (dial-in, dial-out)
Endpoint type (smartphone, tablet, pc, operating system)
Headset type (brand, model, usb, Bluetooth)
Audio type (mono, spatial)
FirstJoinTime: the time stamp when the user joined this conference for the first time
LastJoinTime: the time stamp when the user joined this conference after being disconnected
LeaveTime: the time stamp when the user was disconnected from this conference
TotalDuration: the accumulated time when user was connected to this conference
ListeningDuration: the accumulated time when user was listening into this conference
TalkingDuration: the accumulated time when the user was talking into this conference
TotalJoinAttempts: the total number of user's connections into this conference
TerminationCode: a numeric code that caused the termination of a user' session
Normal call clearing
No Route to Destination
Call Rejected
Network Out Of Order
Network Congestion
Resource Unavailable
Unauthorized
Temporary Failure
   CallSetupDelay: the time a user experienced between initial SIP INVITE and Conference's IVR Ack
   JoinDelay: the time it took for a user to join the conference, starting from initial SIP INVITE
   Max, Min, Avg Input Level: defined as the strength of the audio signal captured by the microphone
   Max, Min, Avg Output Level: defined as the strength of the audio signal rendered by the headphone
   Max, Avg NoiseLevel: defined as an undesired disturbance of a useful voice signal
   Signal to Noise Ratio (SNR): defined as a measured ratio between a useful voice signal and undesired background noise, difference between the speech power and noise power.
   BackgroundNoiseDetection: number of time the system detected a background noise condition
   ImpairmentFactorCode: defined as a code for quantifying the voice quality degradation introduced
   PacketLossRate: defined as the percentage of packets that have been lost in the network. Packet that have been sent but not received by the other party are considered lost.
   PacketDiscardRate; defined as the percentage of packets that have been discarded due to late arrival by the remote party's jitter buffer.
   Max, Avg Jitter: defined as the variability over time of the packet latency across a network
   Max, Avg MouthToEarLatency: defined as the end to end delay between 2 participants in a call, from the input capture by the microphone to the output rendering by the remote headphone
   Max, Avg RoundTripDelay: defined as the round trip delay caused by the network from one endpoint to the media server, and back from the server to the endpoint.
   Max, Avg OneWayDelay: defined as the one way delay caused by the network from one endpoint to the media server.
   Max, Avg EndSystemDelay: defined as the delay caused by both endpoint systems, equivalent to “mouth to ear latency” “one way delay”.
   EchoReturnLoss: defined as the difference in dB between the original signal amplitude and its echo
   EchoReturnLossEnhancement: defined as the difference in dB of the echo level before and after echo cancellation
   MeanOpinionScore: defined as an index for the human user's perspective of the voice quality
   RFactor: Rating Factor is defined as a numerical score derived from voice over IP metrics such as latency, jitter and packet loss, for the segment of the call that is carried over an IP network using an RTP session
   ExternalRFactor: External Rating Factor is defined as a numerical score derived from network latency, for the network segment of the call that is that is not an IP network, such as a cellular or traditional public switched telephone network.
   Frequency/audio bandwidth: defined as the network bandwidth that carries voice packets.
   Data bandwidth: defined as the network bandwidth that does not carries voice or video packets (e.g. data packets, files, email, web, . . . )
   Codec format (G.711, Dolby Voice codec, G.722 . . . ): defined as the audio coder/decoder algorithm used during the voice session.

A participant may also be allowed/enabled to be attending more than one conference. E.g., such participant may be mostly listening to conference A, but also be waiting for a notification from conference B to indicate when it is their turn to give a presentation.

Conference Call Detail Records (cCDR)

In addition of regular “per participant” Call Detail Records, information relative to each conference can be stored in order to record statistics at the Conference level, including the following information:

### ConferenceID

### ConferenceTitle

ConferenceRoomType (mono, spatial, ad hoc, scheduled)

### ConferenceHost

### ExpectedParticipants

### MaxParticipants

### VoipParticipants

### PstnParticipants

### DialInParticipants

### DialOutParticipants

### ConferenceStartedTime

### ConferenceEndTime

### ConferenceDuration

### PstnMinutes

### VoIPMinutes

### MaxActiveSessions

### MaxActiveTalkers

0, 1, 2, 3, 4, 5, more TalkerDuration

### NumberBackgroundNoiseDetection

### Max, Avg PacketLossRate

### Max, Avg PacketDiscardRate

### Max, Avg Jitter

### Max, Avg MouthToEarLatency

### Max, Avg RoundTripDelay

### Max, Avg OneWayDelay

### Max, Avg EndSystemDelay

### MultipartyMeanOpinionScore

### Conference Platform API (Application Programming Interface)

Dolby Voice Solution provides an API in order to allow 3^{rd} party developer or system integrators to access to the information we are gathering.

Most of the Conference Server capabilities can be exposed through this API.

This API allows to embed Conferencing capabilities in other applications, such as through a web page, within a mobile application, or within a Social Business/Media tool.

Both Client and Server capabilities may be exposed through this API.

1-38. (canceled)

39. A system for providing services in a voice conferencing environment, comprising at least one server cluster comprising a plurality of voice conferencing servers, the at least one cluster comprising one or more performance management systems adapted to log at least one performance metric related to at least one of the conferencing servers, wherein at least one of the conferencing servers is assigned to a server cluster which is different from the server cluster which comprises the one or more performance management systems, wherein said conferencing server is automatically activated based on a license-key provided by the performance management system to said conferencing server.

40. The system according to claim 39, wherein at least one voice conferencing server includes at least one model object related to at least one voice conference participant, the model object including information about any of: the participant's location, profile, activity, position, number of other participants in the same room and device capabilities.

41. The system according to claim 39, wherein at least one voice conferencing server is adapted to automatically update at least one of a participant's location information, a participant's presence status, a participant's talking/listening status, a current network activity such as presence of a videostream or file transfer.

42. The system according to claim 41, further including a presence server operatively connected to the at least one voice conferencing server and adapted to determine current user-related information related to any of: current user participation, current user talking and/or presenting, current user requesting not to be disturbed and current user available for instant messaging.

43. A system for providing services in a voice conferencing environment, comprising at least one server cluster comprising a plurality of voice conferencing servers, the at least one cluster comprising one or more performance management systems adapted to log at least one performance metric related to at least one of the conferencing servers, wherein the at least one performance management system is adapted to handle licensing tasks related to the plurality of conferencing servers at a cluster level.

44. The system according to claim 43, wherein at least one voice conferencing server includes at least one model object related to at least one voice conference participant, the model object including information about any of: the participant's location, profile, activity, position, number of other participants in the same room and device capabilities.

45. The system according to claim 43, wherein at least one voice conferencing server is adapted to automatically update at least one of a participant's location information, a participant's presence status, a participant's talking/listening status, a current network activity such as presence of a videostream or file transfer.

46. The system according to claim 45, further including a presence server operatively connected to the at least one voice conferencing server and adapted to determine current user-related information related to any of: current user participation, current user talking and/or presenting, current user requesting not to be disturbed and current user available for instant messaging.

47. A system for providing services in a voice conferencing environment, comprising at least one server cluster comprising a plurality of voice conferencing servers, the at least one cluster comprising one or more performance management systems adapted to log at least one performance metric related to at least one of the conferencing servers, wherein a configuration of the voice conferencing servers of the same cluster is executed automatically by the performance management system based on a server activation request received from each voice conferencing server and on a license file, wherein the license file includes a limited number of licensed ports, wherein said configuration is adapted to enable such voice conferencing servers to participate in a current conference if they are covered by said limited number of licensed ports.

48. The system according to claim 47, wherein such one or more voice conferencing servers not covered by said limited number of ports are not configured.

49. The system according to claim 48, wherein such one or more servers not covered by said license file are configured subsequently upon obtaining a license for such one or more servers.

50. The system according to claim 47, wherein at least one voice conferencing server includes at least one model object related to at least one voice conference participant, the model object including information about any of: the participant's location, profile, activity, position, number of other participants in the same room and device capabilities.

51. The system according to claim 47, wherein at least one voice conferencing server is adapted to automatically update at least one of a participant's location information, a participant's presence status, a participant's talking/listening status, a current network activity such as presence of a videostream or file transfer.

52. The system according to claim 51, further including a presence server operatively connected to the at least one voice conferencing server and adapted to determine current user-related information related to any of: current user participation, current user talking and/or presenting, current user requesting not to be disturbed and current user available for instant messaging.

53. A system for providing services in a voice conferencing environment, comprising at least one server cluster comprising a plurality of voice conferencing servers, the at least one cluster comprising one or more performance management systems adapted to log at least one performance metric related to at least one of the conferencing servers, wherein the performance management system is adapted to perform a license check only during an initial configuration of the voice conference servers such that a failure of the performance management system during a voice conference does not affect the voice conference due to a failed license check during said conference.

54. The system according to claim 53, wherein at least one voice conferencing server includes at least one model object related to at least one voice conference participant, the model object including information about any of: the participant's location, profile, activity, position, number of other participants in the same room and device capabilities.

55. The system according to claim 53, wherein at least one voice conferencing server is adapted to automatically update at least one of a participant's location information, a participant's presence status, a participant's talking/listening status, a current network activity such as presence of a videostream or file transfer.

56. The system according to claim 55, further including a presence server operatively connected to the at least one voice conferencing server and adapted to determine current user-related information related to any of: current user participation, current user talking and/or presenting, current user requesting not to be disturbed and current user available for instant messaging.
